(19) United States
(12) Patent Application Publication
(10) Pub. No.: US 2017/0154316 A1
(43) Pub. Date: Jun. 1, 2017

(54) METHOD, DEVICE AND SYSTEM FOR MANAGING EVENTS IN A CALENDAR

(71) Applicants: Le Holdings (Beijing) Co., Ltd., Beijing (CN); LETV SPORTS CULTURE DEVELOP(BEIJING) CO., LTD., Beijing (CN)

(72) Inventors: Dongchen HUO, Beijing (CN); Ranyang Wang, Beijing (CN); Zhenhua Yan, Beijing (CN)

(21) Appl. No.: 15/246,407

(22) Filed: Aug. 24, 2016

Related U.S. Application Data
(63) Continuation of application No. PCT/CN2016/089479, filed on Jul. 8, 2016.

(30) Foreign Application Priority Data
Dec. 1, 2015 (CN) 201510866857.6

(51) Int. Cl. G06Q 10/10

(52) U.S. Cl. CPC G06Q 10/1095

(57) ABSTRACT

Disclosed are a method, a device and a system for managing events in a calendar. The method includes: sending, by a client, an obtaining request for obtaining user-interested events to a user information server, wherein a target date range for obtaining the user-interested events is carried in the obtaining request; receiving the user-interested events within the target date range sent from the user information server; and marking events in a calendar that a user is interested in according to the received user-interested events.

### CROSS REFERENCE TO RELATED APPLICATIONS

This application is a continuation of International Application No. PCT/CN2016/089479, filed on Jul. 8, 2016, which is based upon and claims priority to Chinese Patent Application No. 201510866857.6, filed on Dec. 1, 2015, the entire contents of which are incorporated herein by reference.

### TECHNICAL FIELD

The present disclosure relates to internet technologies, and more particularly, to a method, a device and a system for managing events in a calendar.

### BACKGROUND

Electronic calendars are available on existing electronic products such as computers, mobile phones and the like to enable users check dates using the electronic calendars. These calendars usually collect national holidays and traditional solar terms, and mark them at corresponding dates. Every time when users view the calendars, they can get information about the holidays or solar terms.

However, in actual usage of calendars, in addition to the information about holidays or solar terms, users often also need to organize some important events which will occur on some dates by the calendars, and edit these events in the calendars, so that users can know information about events which they are interested in and dates for these events by viewing the calendars. However, if a plurality of dates are associated with multiple events in the calendars, users cannot quickly locate the events they are interested in. This brings great inconvenience for users to check events they are interested in. Thus, how to quickly view user-interested events becomes a problem which needs to be solved.

### SUMMARY

The present disclosure provides a method, a device and a system for managing events in a calendar so as to solve the problem in conventional technologies that users cannot quickly locate events they are interested in in a calendar and thereby to quickly view user-interested events in a calendar.

In a first aspect, embodiments of the present disclosure provide a method for managing events in a calendar. The method is mainly applied in a client side and can include the following steps:

sending an obtaining request for obtaining user-interested events to a user information server, wherein a target date range for obtaining the user-interested events is carried in the obtaining request;

receiving the user-interested events within the target date range sent from the user information server; and

marking events in a calendar that a user is interested in according to the received user-interested events.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for managing events in a calendar mentioned by embodiments of the present disclosure.

In a third aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform:

receive an obtaining request for obtaining user-interested events sent from a client, wherein a target date range for obtaining the user-interested events is carried in the obtaining request;

obtain summaries of the user-interested events within the target date range according to the obtaining request;

according to the summaries of the user-interested events, obtain the user-interested events within the target date range from an event query server; and

send the user-interested events within the target date range to the client, so that the client marks events in a calendar that a user is interested in according to the user-interested events within the target date range.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for managing events in a calendar in accordance with some embodiments.

FIG. 2 is a flow chart of another method for managing events in a calendar in accordance with some embodiments.

FIG. 3 is a block diagram showing a device for managing events in a calendar in accordance with some embodiments.

FIG. 4 is a block diagram showing another device for managing events in a calendar, which is based on FIG. 3, in accordance with some embodiments.

FIG. 5 is a block diagram showing a device for managing events in a calendar in accordance with some embodiments.

FIG. 6 is a block diagram showing another device for managing events in a calendar, which is based on FIG. 5, in accordance with some embodiments.

FIG. 7 is a block diagram showing a system for managing events in a calendar in accordance with some embodiments.

FIG. 8 is a block diagram showing a structure of a server in accordance with some embodiments.

FIG. 9 is a block diagram showing a structure of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

In existing calendars, users can conveniently obtain events of interest (or the events they pay attention to) occurring on corresponding dates by viewing the calendars. For example, users can easily get information about holidays, solar terms or information about other user-interested events. However, if a plurality of dates are associated with multiple events in the calendars, users cannot quickly locate the events they are interested in. This brings great inconvenience for users to view calendars.

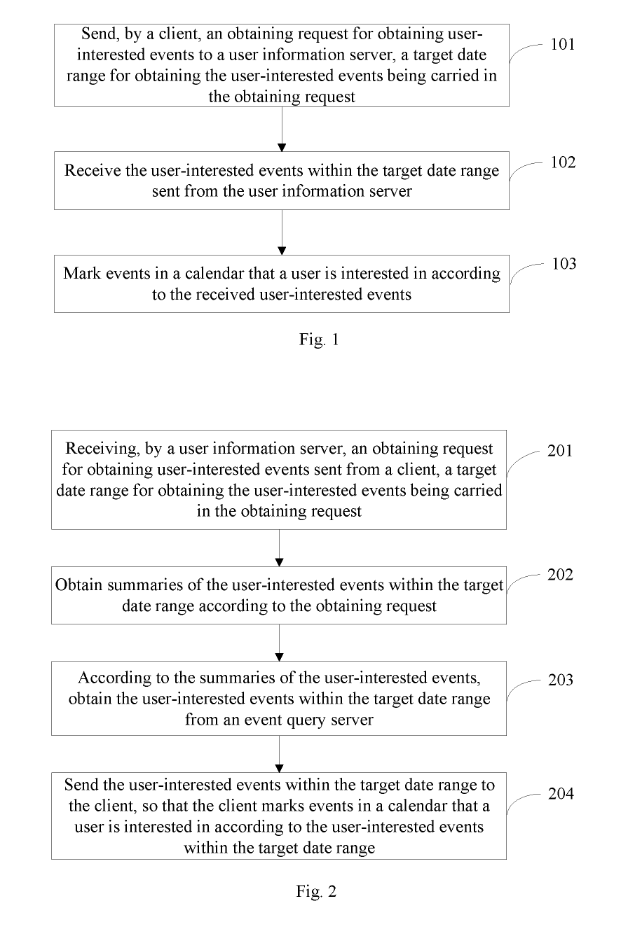

In order to solve the above problem, embodiments of the present disclosure provide a method for managing events in a calendar. The method is mainly applied in a client side. As shown in FIG. 1, the method can include the following steps.

In 101, the client sends an obtaining request for obtaining user-interested events to a user information server. A target date range for obtaining the user-interested events can be carried in the obtaining request.

In existing calendars, information about holidays or solar terms are displayed on dates corresponding to the holidays or solar terms. Or, edition functions can be provided to users, so that users can edit events they are interested in in calendars. Then, when users use the calendars, they can conveniently know the dates and corresponding event information. However, when there are a lot of events in calendars, users cannot quickly locate the events they are interested in. In order to make users quickly locate the events they are interested in when using a calendar, embodiments of the present disclosure provide a method for managing events in a calendar. By performing step 101, a client sends an obtaining request for obtaining user-interested events to a user information server, and a target date range for obtaining the user-interested events can be carried in the obtaining request. Summaries of user-interested events, i.e., a part of information relating to or included in the user-interested events, are recorded in the user information server. For example, a user-interested event can be a sport event, and the summary of the sport event can include the ID of the sport event, team IDs, player IDs, and the like.

In 102, the client receives the user-interested events within the target date range sent from the user information server.

After the client sends the obtaining request for obtaining user-interested events to the user information server in step 101, the user information server, according to the target date range carried in the obtaining request, obtains the user-interested events within the target date range and sends the user-interested events to the client. Thus, after step 101, step 102 is performed in the embodiment of the present disclosure to receive the user-interested events within the target date range sent from the user information server.

In 103, the client marks events in a calendar that a user is interested in according to the received user-interested events.

After receiving the user-interested events within the target date range sent from the user information server in step 102, the client marks events in a calendar that a user is interested in according to the received user-interested events within the target date range. That is, the client highlights the events that the user is interested in in the calendar. In this way, when the user views the calendar, he/she can find the events that he/she is interested in among a plurality of events.

Correspondingly, embodiments of the present disclosure provide a method for managing events in a calendar. The method is mainly applied in a user information server side. As shown in FIG. 2, the method can include the following steps.

In 201, the user information server receives an obtaining request for obtaining user-interested events sent from a client. A target date range for obtaining the user-interested events can be carried in the obtaining request.

After the client sends the obtaining request for obtaining user-interested events, the user information server performs step 201 to receive the obtaining request. Since the target date range for obtaining the user-interested events is carried in the obtaining request, the user information server needs to read the carried target date range from the obtaining request.

In 202, the user information server obtains summaries of the user-interested events within the target date range according to the obtaining request.

Summaries of events occurring on various dates that individual users are interested in can be recorded in the user information server. Specifically, the summaries can be a part of information related to or included in the user-interested events. For example, a user-interested event can be a sport event, and the summary of the sport event can include the ID of the sport event, team IDs, player IDs, and the like. After receiving the obtaining request sent from the client and reading the target date range for obtaining the user-interested events carried in the obtaining request in step 201, the user information server performs step 202 to obtain summaries of the user-interested events within the target date range according to the obtaining request.

In 203, according to the summaries of the user-interested events, the user information server obtains the user-interested events within the target date range from an event query server.

All event information corresponding to various dates are recorded in the event query server. By the summaries within a corresponding date range, it is possible to find user-interested events within the corresponding date range from the event query server. Thus, after obtaining the summaries of the user-interested events within the target date range in step 202, step 203 is performed in the embodiment of the present disclosure to obtain the user-interested events within the target date range from the event query server according to the summaries of the user-interested events. For example, the summary of a sport event can include the ID of the sport event, team IDs, player IDs, and the like, and then the user information server can find in the event query server sport event information within the target date range corresponding to the ID of the sport event, information about the matches that the teams corresponding to the team IDs take part in, and information about the matches that the players corresponding to the player IDs take part in.

In 204, the user information server sends the user-interested events within the target date range to the client, so that the client marks events in a calendar that a user is interested in according to the user-interested events within the target date range.

After obtaining the user-interested events within the target date range from the event query server in step 203, step 204 is performed in the embodiment of the present disclosure to send the user-interested events within the target date range to the client, so that the client marks events in a calendar that a user is interested in according to the user-interested events within the target date range. That is, the client highlights the events that the user is interested in in the calendar. In this way, when the user views the calendar, he/she can find the events that he/she is interested in among a plurality of events.

In the method for managing events in a calendar provided by embodiments of the present disclosure, a user information server, according to an obtaining request for obtaining user-interested events which is sent from a client and in which a target date range is carried, queries summaries of user-interested events within the target date range. The user information server, according to the summaries of the user-interested events, obtains the user-interested events, which are corresponding to the summaries, from an event query server, and sends the queried user-interested events within the target date range to the client, so that the client marks events in a calendar that a user is interested in according to the user-interested events. In conventional technologies, if a plurality of dates are associated with multiple events in a calendar, users cannot quickly locate the events they are interested in. As compared with the prior technologies, by information interactions among the client, the user information server and the event query server, the technical solutions in embodiments of the present disclosure can realize quick viewing of user-interested events in calendars.

For convenience in understanding of the methods described in connection with FIGS. 1 and 2, detailed description regarding the method for managing events in a calendar provided by embodiments of the present disclosure will be made as follows with an example that user-interested events are sport events, and a user pays attention on sport events in a calendar.

In embodiments of the present disclosure, in order to make a user quickly located the event information he/she is interested in when using a calendar, which usually records a lot of event information, an obtaining request for obtaining user-interested events is sent to a user information server in embodiments of the present disclosure. The obtaining request is sent for the purpose of obtaining user-interested events within a certain date range, and thus a user can set the date range for obtaining user-interested events by time options provided by the client before the client sends the obtaining request. This is an optional implementation. Then, the client can obtain the target date range set by the user. The target date range can be a date range in a single day or a date range that lasts for several days. After obtaining the target date range from the time options in the calendar, the client can add the target date range into an asynchronous request for obtaining user-interested events and sends the asynchronous request to the user information server. In actual situations, a JavaScript program in the client can send an ajax asynchronous request for obtaining user-interested events to the user information server.

It should be noted that the JavaScript program in the client can also send an ajax synchronous request for obtaining user-interested events to the user information server. Sending any one of the ajax synchronous and asynchronous requests can obtain user-interested events. However, because the JavaScript program is a single-threaded program, execution of the ajax request may take a certain period of time, and sometimes results cannot be returned due to network failures. If the synchronous request is sent, the subsequent codes can be executed only after results are returned by ajax. On the contrary, if the asynchronous request is sent, the subsequent codes can be executed even without the results returned by ajax. Thus, in order to not influence other operations of the user while obtaining user-interested events, an ajax asynchronous request is sent to the user information server by default to obtain the user-interested events in embodiments of the present disclosure.

In embodiments of the present disclosure, summaries of sport events occurring on various dates that individual users are interested in can be recorded in the user information server. Specifically, the summaries can be a part of information related to or included in the sport events. For example, the summaries can include IDs of sport events that users are interested in, IDs of teams, IDs of players, and the like. After receiving the obtaining request for obtaining user-interested sport events sent from the client, the user information server reads the target date range carried in the obtaining request, and obtains summaries that users are interested in within the target date range (i.e., information about IDs of sport events within the target date range that users are interested in, team IDs, player IDs, and the like) according to the summaries of the sport events recorded in the user information server.

During one sport event, a plurality of matches may be organized, and the same team may take part in different matches, and the same player may take part in different matches. In order to perform statistics on information of all sport events, embodiments of the present disclosure provide an event query server, in which information about all sport events occurring on various dates are recorded. After receiving the obtaining request for obtaining user-interested sport events from the client and obtaining the summaries of the sport events within the target date range according to the target date range carried in the obtaining request, the user information server searches in the event query server for information about all matches corresponding to the summaries within the target date range according to the summaries within the target date range. In actual query, the user information server can, according to the obtained event IDs within the target date range, search all the matches within the target date range which belong to the events; the user information server can, according to the obtained team IDs within the target date range, search all the matches within the target date range which the teams corresponding to the team IDs take part in; and the user information server can, according to the obtained player IDs within the target date range, search all the matches within the target date range which the players corresponding to the player IDs take part in.

For example, the target date range obtained by the client from the time options in the calendar is the whole day of October 10, the target date range (i.e., October 10) is carried in the obtaining request for obtaining user-interested sport events, and the obtaining request is sent to the user information server. After receiving the obtaining request, the user information server reads the target date range in the request, and obtains summaries of user-interested sport events within the target date range (i.e., sport events occurring on October 10) from the summaries of sport events recorded in the user information server itself. For example, the summaries can include IDs of sport events, team IDs, and player IDs and the like. Then, according to the obtained IDs of sport events, the user information server can search in the event query server for all matches occurring on October 10 which belong to the sport events corresponding to the sport event IDs. For example, if an obtained ID of sport event is “football”, information about all football matches occurring on October 10 is obtained. According to the obtained team IDs, the user information server can search in the event query server for information about all matches that the teams corresponding to the team IDs take part in on October 10. For example, if an obtained team ID is “HD”, the user information server can obtain all the matches which the team “HD” takes part in on October 10. According to the obtained player IDs, the user information server can search in the event query server for information about all matches that the players corresponding to the player IDs take part in on October 10. For example, if an obtained player ID is “WDL”, the user information server can obtain all the matches which the player “WDL” takes part in on October 10.

After finding all matches within the target date range which the user is interested in from the event query server according to the summaries of sport events within the target date range, the user information server gathers the matches corresponding to respective summaries. There may be duplications among the matches corresponding to respective summaries. For example, if the player “WDL” belongs to the team “HD”, there will be duplications between the matches which the player “WDL” takes part in on October 10 and the matches which the team “HD” takes part in on October 10. As another example, if the team “HD” is a football team, there will be duplications between the matches which the team “HD” takes part in on October 10 and the matches occurring on October 10 with the event ID of “football”. Thus, in embodiments of the present disclosure, after gathering the matches corresponding to respective summaries, duplication removal and/or filtering can be performed on all the gathered matches so as to send the match information after duplication removal to the client. The client can organize the match information after duplication removal into a match list, and mark sport events in the calendar that the user is interested in according to the match information after duplication removal which is recorded in the match list. In this way, when viewing the calendar, the user can quickly locate the sport events which he/she is interested in.

In the above descriptions, user-interested events in a calendar are exemplified as sport events which a user is interested in. Rather, the events which a user is interested in can be of other topics, for example, a user can be interested in entertainment events, news events and the like, and embodiments of the present disclosure do not impose limitations on the topics of the events which a user is interested in in the calendar. Any event is suitable as long as the event can be managed (for example, marked) using the method for managing events in a calendar provided by embodiments of the present disclosure.

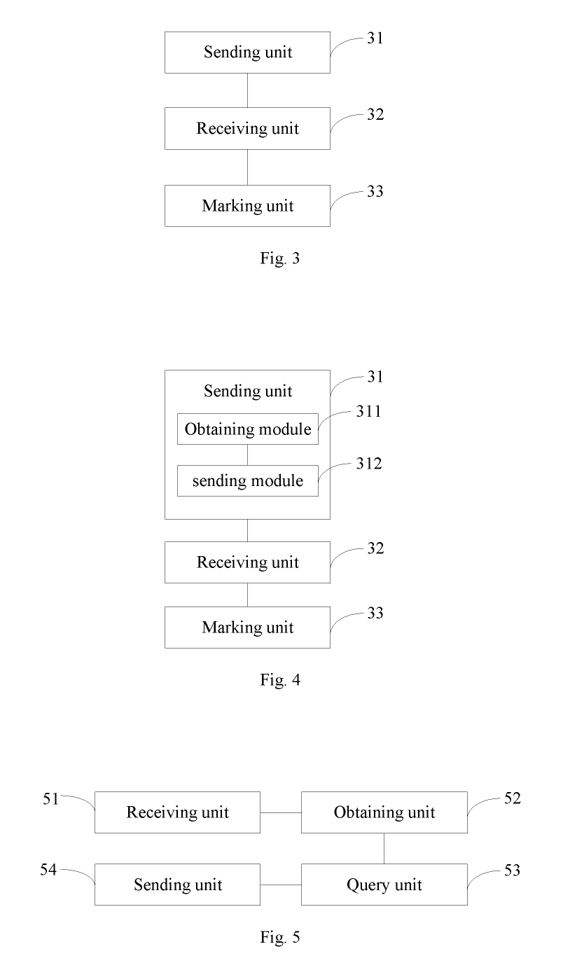

Embodiments of the present disclosure provide a device for managing events in a calendar to implement the above method described in connection with FIG. 1. The device is mainly applied in a client, or can be independent from the client but have data interactions with the client. As shown in FIG. 3, the device includes a sending unit 31, a receiving unit 32 and a marking unit 33.

The sending unit 31 is configured to send an obtaining request for obtaining user-interested events to a user information server. A target date range for obtaining the user-interested events can be carried in the obtaining request.

The receiving unit 32 is configured to receive the user-interested events within the target date range sent from the user information server.

The marking unit 33 is configured to mark events in a calendar that a user is interested in according to the received user-interested events.

Further, as shown in FIG. 4, the sending unit 31 includes an obtaining module 311 and a sending module 312.

The obtaining module 311 is configured to obtain the target date range from time options in the calendar.

The sending module 312 is configured to add the target date range to an asynchronous request for obtaining the user-interested events and send the asynchronous request to the user information server, so that the user information server obtains summaries of the user-interested events within the target date range.

Further, the receiving unit 32 is configured to receive user-interested events, on which duplicate removal and filtering is performed, within the target date range from the user information server. The user-interested events on which duplicate removal and filtering is performed are obtained by gathering the user-interested events corresponding to the summaries of the user-interested events within the target date range and removing duplicates among the user-interested events.

Further, the marking unit 33 is configured to mark events in the calendar that the user is interested in according to the received user-interested events on which duplicate removal and filtering is performed.

Correspondingly to the device as shown in FIG. 3, embodiments of the present disclosure provide a device for managing events in a calendar to implement the above method described in connection with FIG. 2. The device is mainly applied in a user information server side, or can be independent from the user information server but have data interactions with the user information server. As shown in FIG. 5, the device includes a receiving unit 51, an obtaining unit 52, a query unit 53 and a sending unit 54.

The receiving unit 51 is configured to receive an obtaining request for obtaining user-interested events sent from a client. A target date range for obtaining the user-interested events can be carried in the obtaining request.

The obtaining unit 52 is configured to obtain summaries of the user-interested events within the target date range according to the obtaining request.

The query unit 53 is configured to, according to the summaries of the user-interested events, obtain the user-interested events within the target date range from an event query server.

The sending unit 54 is configured to send the user-interested events within the target date range to the client, so that the client marks events in a calendar that a user is interested in according to the user-interested events within the target date range.

Further, the receiving unit 51 is configured to receive an asynchronous request for obtaining user-interested events sent from the client. The target date range for obtaining the user-interested events can be carried in the asynchronous request.

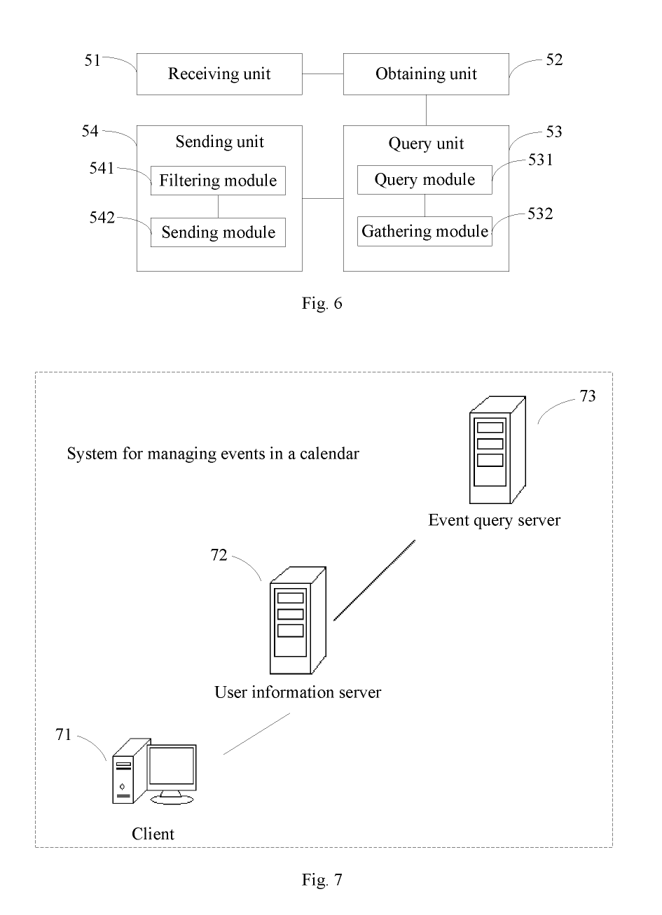

Further, as shown in FIG. 6, the query unit 53 includes a query module 531 and a gathering module 532.

The query module 531 is configured to query the user-interested events within the target date range corresponding to the summaries from the event query server.

The gathering module 532 is configured to gather the user-interested events within the target date range corresponding to the summaries.

Further, the sending unit 54 includes a filtering module 541 and a sending module 542.

The filtering module 541 is configured to perform duplicate removal and filtering on the gathered user-interested events within the target date range corresponding to the summaries.

The sending module 542 is configured to send the user-interested events after duplicate removal and filtering to the client.

It should be noted that the functions of respective units or modules in the above devices for managing events in a calendar according to embodiments of the present disclosure can be realized by hardware processors.

In the devices for managing events in a calendar provided by embodiments of the present disclosure, a user information server, according to an obtaining request for obtaining user-interested events which is sent from a client and in which a target date range is carried, queries summaries of user-interested events within the target date range. The user information server, according to the summaries of the user-interested events, obtains the user-interested events, which are corresponding to the summaries, from an event query server, and sends the queried user-interested events within the target date range to the client, so that the client marks events in a calendar that a user is interested in according to the user-interested events. In conventional technologies, if a plurality of dates are associated with multiple events in a calendar, users cannot quickly locate the events they are interested in. As compared with the prior technologies, by information interactions among the client, the user information server and the event query server, the technical solutions in embodiments of the present disclosure can realize quick viewing of user-interested events in calendars.

In addition, in the devices for managing events in a calendar provided by embodiments of the present disclosure, duplicate removal and filtering is performed on the user-interested events obtained from the event query server so that the client can obtain accurate information about user-interested events. Thus, the client can precisely mark events in a calendar that a user is interested in.

In order to implement the above methods described in connection with FIGS. 1 and 2, embodiments of the present disclosure provide a system for managing events in a calendar in which the devices described in connection with FIGS. 3, 4, 5 and/or 6 are applied. As shown in FIG. 7, the system includes a client 71, a user information server 72 and an event query server 73. The client 71 includes the device as shown in FIG. 3 or 4, and the user information server 72 includes the device as shown in FIG. 5 or 6.

In the system for managing events in a calendar provided by embodiments of the present disclosure, a user information server, according to an obtaining request for obtaining user-interested events which is sent from a client and in which a target date range is carried, queries summaries of user-interested events within the target date range. The user information server, according to the summaries of the user-interested events, obtains the user-interested events, which are corresponding to the summaries, from an event query server, and sends the queried user-interested events within the target date range to the client, so that the client marks events in a calendar that a user is interested in according to the user-interested events. In conventional technologies, if a plurality of dates are associated with multiple events in a calendar, users cannot quickly locate the events they are interested in. As compared with the prior technologies, by information interactions among the client, the user information server and the event query server, the technical solutions in embodiments of the present disclosure can realize quick viewing of user-interested events in calendars.

In addition, in the system for managing events in a calendar provided by embodiments of the present disclosure, duplicate removal and filtering is performed on the user-interested events obtained from the event query server so that the client can obtain accurate information about user-interested events. Thus, the client can precisely mark events in a calendar that a user is interested in.

It should be noted that the functions of respective units or modules in the above devices for managing events in a calendar according to embodiments of the present disclosure can be realized by hardware processors.

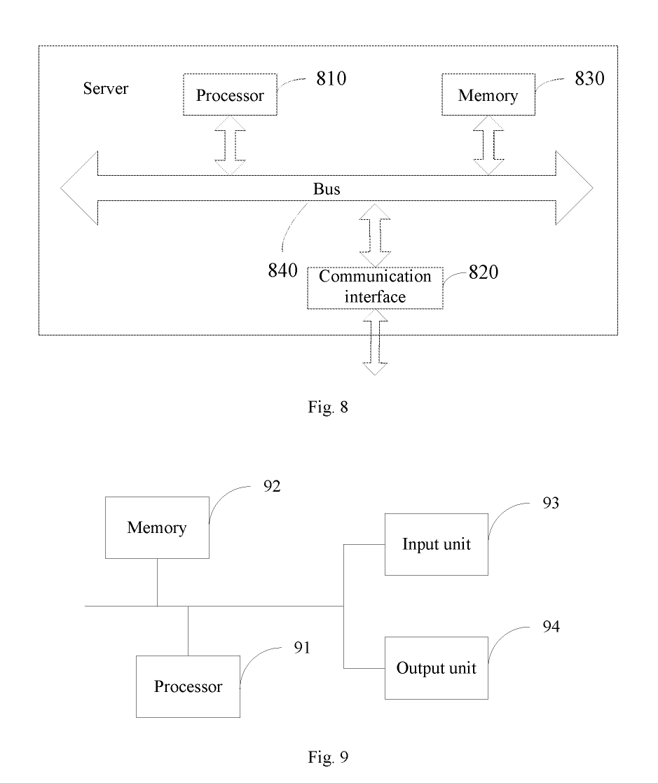

FIG. 8 is a block diagram showing a physical structure of a server. As shown in FIG. 8, the server can include a processor 810, a communication interface 820, a memory 830 and a bus 840. The processor 810, the communication interface 820 and the memory 830 communicate with each other via the bus 840. The communication interface 820 may be used for information transmission between the server and a client. The processor 810 calls logic instructions in the memory 83 to perform the following method: sending, by a client, an obtaining request for obtaining user-interested events to a user information server, wherein a target date range for obtaining the user-interested events is carried in the obtaining request; receiving the user-interested events within the target date range sent from the user information server; and marking events in a calendar that a user is interested in according to the received user-interested events.

In addition, the logic instructions in the memory 830 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for managing events in a calendar mentioned by embodiments of the present disclosure.

FIG. 9 is a block diagram of an electronic device which is configured to perform the methods for managing events in a calendar according to an embodiment of the present disclosure. As shown in FIG. 9, the device includes: one or more processors 91 and memory 92. A processor 91 is showed in FIG. 9 for an example.

Device which is configured to perform the methods for managing events in a calendar can also include: input unit 93 and output unit 94.

Processor 91, memory 92, input unit 93 and output unit 94 can be connected by BUS or other methods, and BUS connecting is showed in FIG. 9 for an example.

Memory 92 can be used for storing non-transitory software program, non-transitory computer executable program and modules as a non-transitory computer-readable storage medium, such as corresponding program instructions/modules for the methods for managing events in a calendar mentioned by embodiments of the present disclosure (such as shown in FIG. 3, sending unit 31, receiving unit 32 and marking unit 33). Processor 91 performs kinds of functions and managing events in a calendar of the electronic device by executing non-transitory software program, instructions and modules which are stored in memory 92, thereby realizes the methods for managing events in a calendar mentioned by embodiments of the present disclosure.

Memory 92 can include program storage area and data storage area, thereby the operating system and applications required by at least one function can be stored in program storage area and data created by using the device for managing events in a calendar can be stored in data storage area. Furthermore, memory 92 can include high speed Random-access memory (RAM) or non-volatile memory such as magnetic disk storage device, flash memory device or other non-volatile solid state storage devices. In some embodiments, memory 92 can include long-distance setup memories relative to processor 91, which can communicate with the device for managing events in a calendar by networks. The examples of said networks are including but not limited to Internet, Intranet, LAN, mobile Internet and their combinations.

Input unit 93 can be used to receive inputted number, character information and key signals causing user configures and function controls of the device for managing events in a calendar. Output unit 94 can include a display screen or a display device.

The said module or modules are stored in memory 92 and perform the methods for managing events in a calendar when executed by one or more processors 91.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for managing events in a calendar, implemented by a client, comprising:
sending an obtaining request for obtaining user-interested events to a user information server, wherein a target date range for obtaining the user-interested events is carried in the obtaining request;
receiving the user-interested events within the target date range sent from the user information server; and
marking events in a calendar that a user is interested in according to the received user-interested events.

2. The method according to claim 1, wherein the sending of the obtaining request to the user information server by the client comprises:
obtaining, by the client, the target date range from time options in the calendar; and
adding the target date range to an asynchronous request for obtaining the user-interested events and sending the asynchronous request to the user information server, so that the user information server obtains summaries of the user-interested events within the target date range.

3. The method according to claim 2, wherein the receiving of the user-interested events within the target date range sent from the user information server comprises:
receiving user-interested events, on which duplicate removal and filtering is performed, within the target date range from the user information server, wherein the user-interested events on which duplicate removal and filtering is performed are obtained by gathering the user-interested events corresponding to the summaries of the user-interested events within the target date range and removing duplicates among the user-interested events.

4. The method according to claim 3, wherein the marking of events in the calendar that the user is interested in according to the received user-interested events comprises:
marking events in the calendar that the user is interested in according to the received user-interested events on which duplicate removal and filtering is performed.

5. An electronic device, comprising:
at least one processor; and
a memory communicably connected with the at least one processor for storing instructions executable by the at least one processor, wherein execution of the instructions by the at least one processor causes the at least one processor to:
send an obtaining request for obtaining user-interested events to a user information server, wherein a target date range for obtaining the user-interested events is carried in the obtaining request;
receive the user-interested events within the target date range sent from the user information server; and
mark events in a calendar that a user is interested in according to the received user-interested events.

6. The electronic device according to claim 5, wherein the sending of the obtaining request to the user information server comprises:
obtaining the target date range from time options in the calendar; and
adding the target date range to an asynchronous request for obtaining the user-interested events and sending the asynchronous request to the user information server, so that the user information server obtains summaries of the user-interested events within the target date range.

7. The electronic device according to claim 6, wherein the receiving of the user-interested events within the target date range sent from the user information server comprises:
receiving user-interested events, on which duplicate removal and filtering is performed, within the target date range from the user information server, wherein the user-interested events on which duplicate removal and filtering is performed are obtained by gathering the user-interested events corresponding to the summaries of the user-interested events within the target date range and removing duplicates among the user-interested events.

8. The electronic device according to claim 7, wherein the marking of events in the calendar that the user is interested in according to the received user-interested events comprises:
marking events in the calendar that the user is interested in according to the received user-interested events on which duplicate removal and filtering is performed.

9. An electronic device, comprising:
at least one processor; and
a memory communicably connected with the at least one processor for storing instructions executable by the at least one processor, wherein execution of the instructions by the at least one processor causes the at least one processor to:
receive an obtaining request for obtaining user-interested events sent from a client, wherein a target date range for obtaining the user-interested events is carried in the obtaining request;
obtain summaries of the user-interested events within the target date range according to the obtaining request;
according to the summaries of the user-interested events, obtain the user-interested events within the target date range from an event query server; and
send the user-interested events within the target date range to the client, so that the client marks events in a calendar that a user is interested in according to the user-interested events within the target date range.

10. The electronic device according to claim 9, wherein the receiving of the obtaining request for obtaining user-interested events sent from the client comprises:
receiving an asynchronous request for obtaining user-interested events sent from the client, wherein the target date range for obtaining the user-interested events is carried in the asynchronous request.

11. The electronic device according to claim 9, wherein the obtaining of the user-interested events within the target date range from the event query server according to the summaries of the user-interested events comprises:
querying the user-interested events within the target date range corresponding to the summaries from the event query server; and
gathering the user-interested events within the target date range corresponding to the summaries.

12. The electronic device according to claim 11, wherein the sending of the user-interested events within the target date range to the client comprises:
performing duplicate removal and filtering on the gathered user-interested events within the target date range corresponding to the summaries; and
sending the user-interested events after duplicate removal and filtering to the client.
